(19) United States
(12) Patent Application Publication
(10) Pub. No.: US 2015/0272012 A1
(43) Pub. Date: Oct. 1, 2015

(54) DISTRIBUTION MACHINE

(71) Applicant: KUHN-AUDUREAU S.A., La Copechagniere (FR)

(72) Inventors: Christophe Roger, Nantes (FR); Charly Garnier, Saint Philibert de Bouaine (FR)

(73) Assignee: KUHN-AUDUREAU S.A., La Copechagniere (FR)

(21) Appl. No.: 14/410,318

(22) PCT Filed: Jul. 9, 2013
(86) PCT No.: PCT/FR13/51636

§ 371 Date: Dec. 22, 2014

(30) Foreign Application Priority Data
Jul. 12, 2012 (FR) 1256742

(51) Int. Cl. A01F 29/00; B02C 18/14

(52) U.S. Cl. CPC A01F 29/005; B02C 18/143

(57) ABSTRACT

A machine for distribution of products for animals, including a bucket including an opening toward a casing including a turbine including a disc. The disc includes knives and blades extending to a respective front face adjacent the opening. At least one row of knives extends between the disc and a front face of a blade and in the extension of that blade, with a first knife adjacent to the front face and a last knife adjacent to the disc. At least one additional first knife is arranged between the front face of a blade and a wall of the casing pierced with the opening, the turbine including at least one branch including the front face of a blade. The at least one branch extends from a periphery of a central plate adjacent the opening, remote from the disc and connected to the blade whose front face belongs to the branch.

The present invention relates to a machine for the distribution of products for the feeding or bedding of animals, comprising a bucket with an opening for the passage of the products toward a casing comprising a first wall pierced by the opening and a second wall between which a turbine is mounted that can rotate around a rotation axis, the turbine comprising a disc with rows of knives and blades oriented in a substantially radial direction of the disc and each extending from the disc to a respective front face adjacent to the opening, at least one row of knives extending between the disc and the front face of a blade and being arranged in the extension of that blade, said at least one row of knives comprising a first knife adjacent to the front face and a last knife adjacent to the disc, at least one additional first knife being arranged between the front face of a blade and the first wall of the casing, the turbine comprising at least one branch comprising the front face of a blade.

On such a machine, products such as straw or hay are inserted into the bucket and moved toward the opening for example by means of a movable conveying band situated at the bottom of the bucket. The products encounter an unraveling drum allowing a homogenous supply of the turbine and a constant flow of products toward it. The products next pass through the opening, from which they enter the casing, in which the turbine rotates at a high speed. Under the effect of that rotation, the products are moved toward a periphery of the turbine while sliding along the blades and are chopped by the action of the knives cooperating with one or more counter knives distributed along the perimeter of the casing. Through a blowing effect due in particular to the blades, the chopped products are next thrown out through a discharge chute and directed toward the ground or troughs, for example.

On a machine known from document FR 2 598 059 A1, the rows of knives are not as wide as the blades in the extension of which the rows are arranged. As a result, in particular, the first knife of each row is arranged slightly set back from the front face of the corresponding blade. Thus, the products sliding along a blade, near its edge close to the opening, are centrifuged without being recut or are not recut in short enough strands. Furthermore, in the area of the casing between the front face and the first wall of the casing, the products are chopped poorly or not at all. The products chopped poorly or not at all increase the power consumed by the machine, the time requested to work and throw out the products contained in the bucket, as well as the risk of jamming, in particular during the use of dense and/or wet and/or long-stranded products. Additionally, the products thrown outside the casing are heterogeneous. Another problem is that the blades are formed by single plane metal sheets perpendicular to the disc, which additionally do not meet in the central part of the turbine. In fact, both the blades and the turbine in its entirety lack rigidity.

On another machine known from document DE 88 13 158 U1, the turbine comprises a first disc adjacent to the products and a second disc parallel to one another. The turbine is mounted on a rotation axis in a circular casing, the diameter of which is barely larger than that of the first disc. Rows of knives are arranged between the inner faces of those two discs, near their periphery. The first disc carries knives on its outer face that shred the products, for example in the form of a bale. When the turbine rotates, the shredded products move along the outer face of the first disc toward its periphery. The shredded and centrifuged products enter the annular space separating the casing from the first disc, to be picked up again by the rows of knives in order to be chopped. The rows of knives are therefore supplied through a narrow passage that considerably increases the time necessary to chop and throw out the products. Furthermore, this supply is done in a direction parallel to the rotation axis of the turbine, resulting in irregular chopping along the rows of knives.

On another machine known from document EP 2 436 261 A1, the turbine comprises a hollow central cylinder around which thin plane metal sheets, connected to said cylinder, are distributed. This hollow cylinder and these plane metal sheets extend projecting perpendicularly from the disc. This design has many hollows and sharp edges that hinder the flow of products from the center of the rotating turbine toward its periphery. Furthermore, products may easily remain stuck in these geometrical unevennesses. This is in particular the case within the hollow cylinder, or even in the V-shaped hollow that separates two plane metal sheets. Accumulations of products can form an unbalance that throws the rotating turbine off balance.

Another machine known from document EP 0 568 961 A2 is according to the preamble of claim 1. On that machine, the turbine comprises a main disc passed through by a rotary shaft and supporting rows of knives extending radially and arranged overhanging the disc. The main disc carries blades formed by plane metal sheets substantially perpendicular to the main disc and branches in the form of folded metal sheets. Each branch originates at the disc and extends toward the knives while diverging from the disc and following the contour of the corresponding plane metal sheet. Such a blade is not very rigid in itself. Each branch is connected to the disc in a respective zone radially distant from the rotary shaft. The incline of each blade relative to a radius of the main disc is adjustable by assembling the blade on an axis parallel to the rotary shaft, said axis is placed near the area where the branch converges toward the main disc. This method of connecting the blades to the main disc does not allow the blades to impart a significant additional rigidity to the main disc. The main disc and blades assembly therefore lacks rigidity. One problem is therefore that the forces induced by the knives on the rotating turbine, in particular due to their overhang with respect to the main disc, cause significant deformations of the turbine. Furthermore, the turbine carries a second disc placed between the main disc and the bucket, and removably connected to the rotary shaft. This second disc is placed, along the axis of rotation of the turbine, substantially at the level of additional first knives carried by the main disc. That second disc carries branches extending radially. That second disc and its branches carry knives oriented toward the bucket. When the turbine rotates, these knives shred the products present in the bucket and part of those products is oriented radially toward the additional first knives. However, the second disc reduces the passage section for the products from the bucket toward the main disc, and represents an obstacle to the movement of said products along the axis of rotation. As a result, under the effect of the centrifugal force, only a reduced quantity of product reaches the knives of the main disc placed in the immediate vicinity thereof. Furthermore, over time, products can accumulate in the space present between the main disc and the second disc. That second disc can nevertheless be removed such that the turbine works with only the main disc. In that case, however, the products coming from the bucket and arriving against the main disc are centrifuged in large part toward the knives close to the main disc, while the knives remote from the main disc, in particular the additional first knives, are not supplied as well. One problem with this machine is therefore that the products are not distributed homogenously over the width of the rows of knives when the turbine rotates, which deteriorates the quality of the chopping.

The aim of the present invention is to have a machine that does not have the aforementioned drawbacks.

To that end, the invention is characterized in that said at least one branch of the turbine extends from a periphery of a central plate adjacent to the opening, remote from the disc and connected to the blade whose front face belongs to said at least one branch. The products crossing the opening of the casing come into contact with the central plate, the smooth and regular surface of which prevents any possible accumulation of products at the center of the turbine. Additionally, this central plate allows part of the products, under the effect of the centrifugal force, to slide radially, from the rotation axis, along the central plate, then along the branch toward the space situated between the front face of that branch and the first wall of the casing pierced by the opening. During a revolution of the turbine around its rotation axis, this area is passed through by the at least one additional knife, the supply of which is improved by the arrangement of the branch according to the invention. The products sliding along the branch, including those at the front face adjacent to the opening, are completely chopped, and those present in the area of the casing situated between the front blade face and the first wall are also recut. The rest of the products slide along the central plate and move more or less radially at least between two adjacent blades until they are chopped by the knives of a row of knives. In this way, the products sliding along the blades are well recut. The products thrown outside the casing are more homogenous. The improved chopping quality reduces the power consumed by the machine, the time requested to work and throw out the products contained in the bucket, as well as the risk of jamming, in particular during the use of dense and/or wet and/or long-stranded products. Lastly, this arrangement of the turbine with a central plate remote from the disc and connected to the blade, and from which a branch carrying the front face of that blade extends, at the same time increases the rigidity of said blade and of the turbine in its entirety.

According to one advantageous feature of the invention, said at least one branch extends toward said at least one additional knife. In this way, the products sliding along said branch toward the periphery of the turbine are immediately chopped by that additional first knife placed in the extension of that branch.

According to another advantageous feature of the invention, said at least one additional first knife is placed, along the rotation axis, substantially in the extension of a row of knives. The products encountering a blade become distributed in a first part sliding along the branch of that blade, and a second part moving more or less radially between that blade and an adjacent blade. The first part is chopped by the at least one additional first knife, while at the same time, the second part is chopped by the knives of the row of knives in the extension of which the additional first knife is arranged. The number of revolutions of the turbine necessary to chop all of the products from the bucket is thus reduced, and the products are chopped quickly.

Other features and advantages of the invention will emerge from the following description, in reference to the appended drawings, which show one non-limiting example embodiment of the machine according to the invention.

In these drawings:

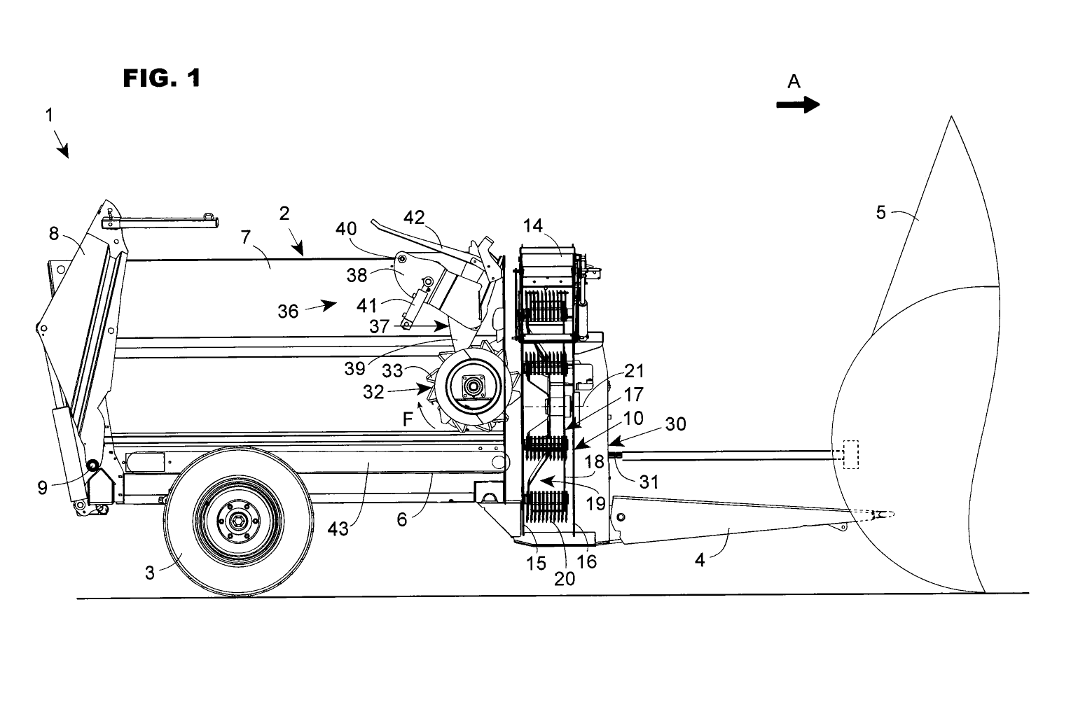

FIG. 1 shows a side view with a partial cross-section of a machine according to the invention;

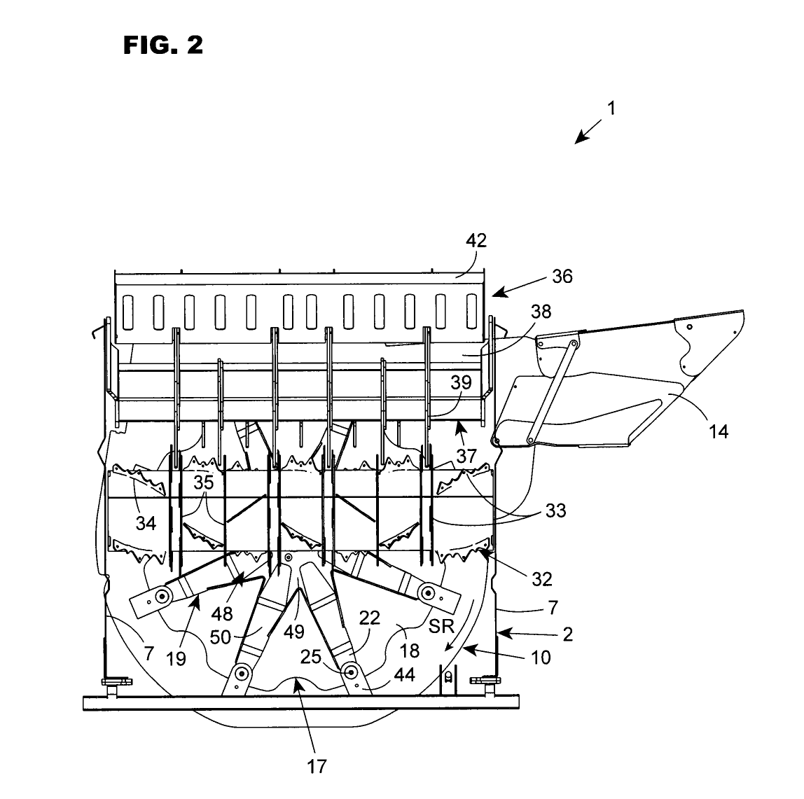

FIG. 2 shows a front view of the unraveling drum;

FIG. 3 shows a detailed view of an arrangement, in a first position, of the machine according to the invention;

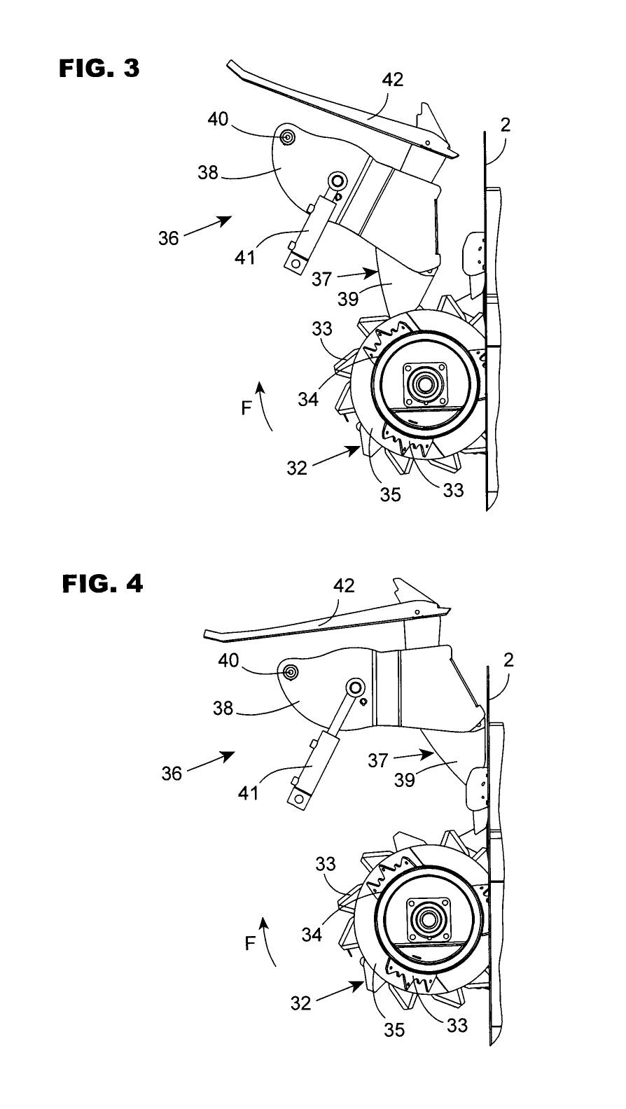

FIG. 4 shows a detailed view of the arrangement, in a second position, of the machine according to the invention;

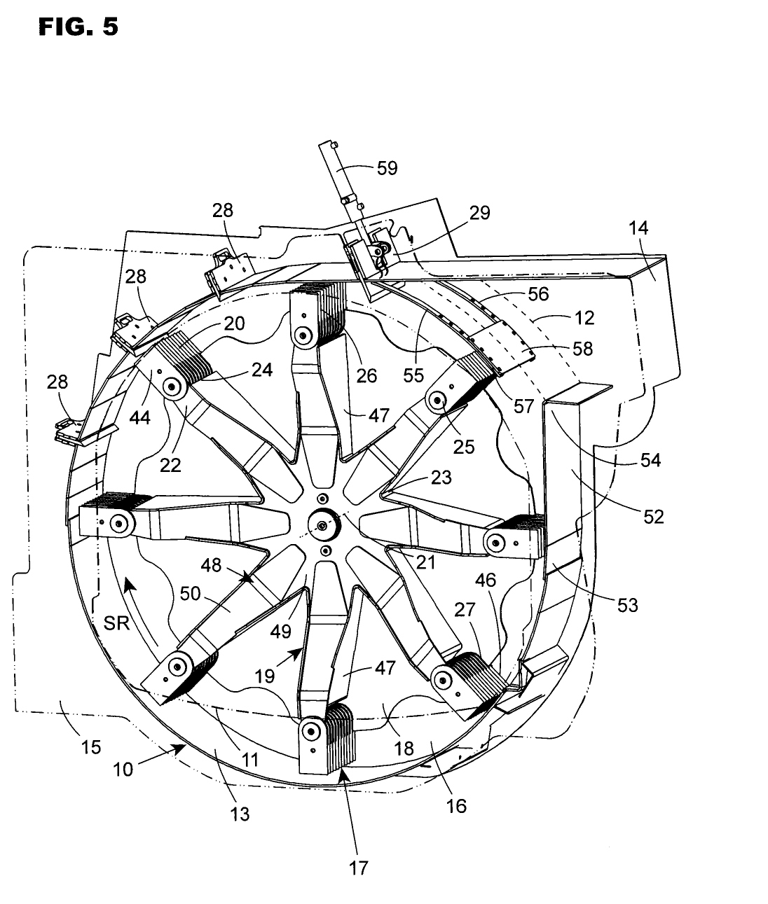

FIG. 5 shows a perspective view of the casing and the turbine;

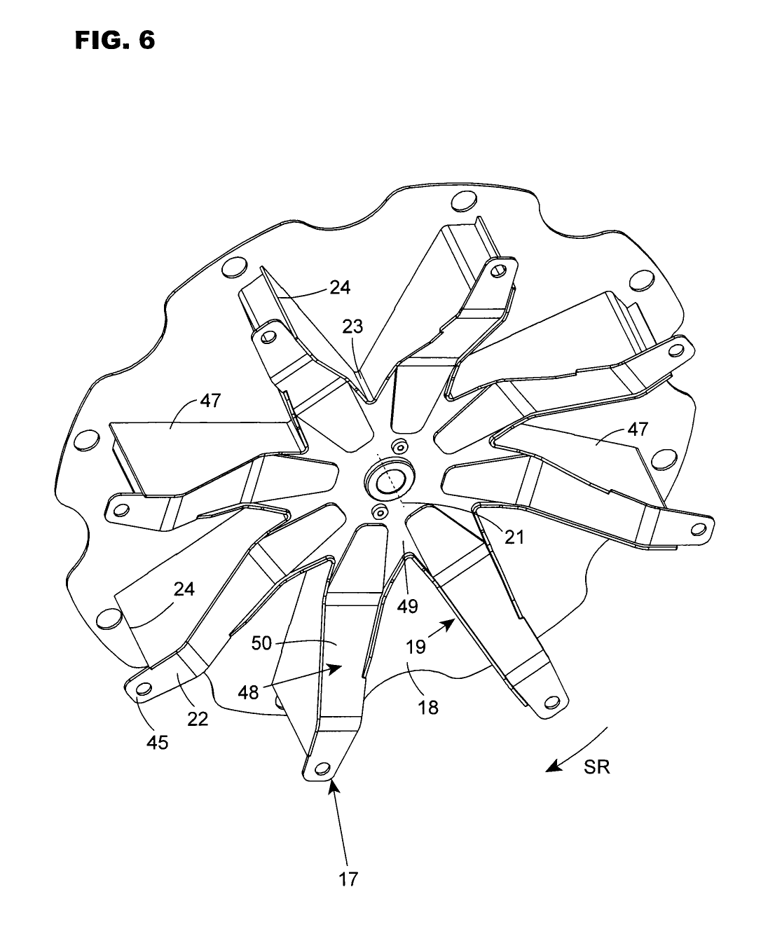

FIG. 6 shows a perspective view of the turbine without the knives;

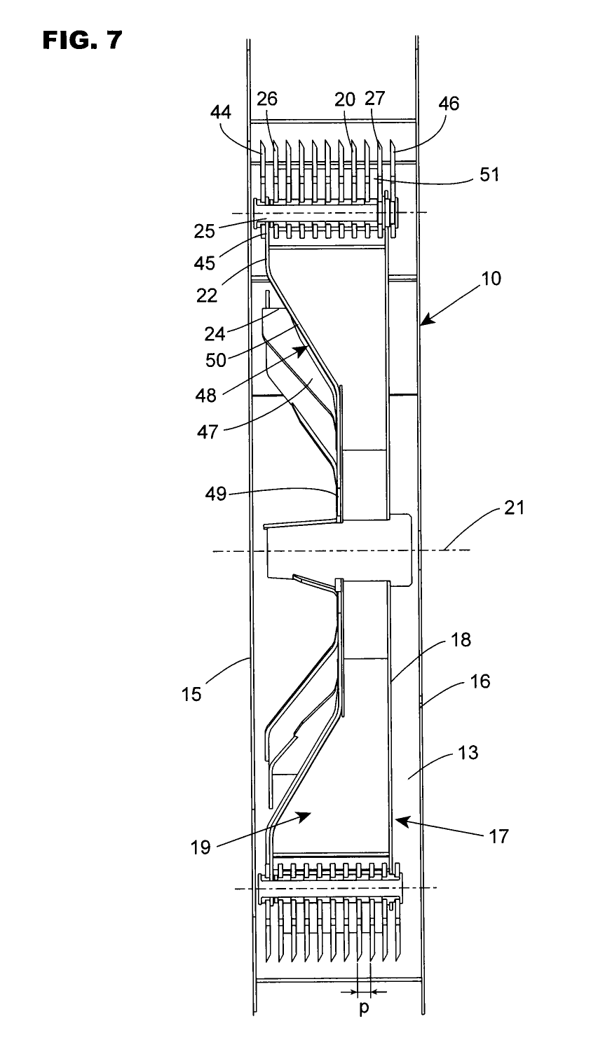

FIG. 7 shows a view of the casing and the turbine, in cross-section in a plane passing through the rotation axis.

As shown in FIG. 1, the machine (1) according to the invention comprises a bucket (2) with two carrier wheels (3) and a drawbar (4) for hitching to a tractor (5) used to drive the machine (1) and move it. The arrow (A) indicates the normal direction of advance of the machine (1). The indications “front” and “rear” are provided in reference to that direction of advance. The bucket (2) can advantageously be moved heightwise relative to the carrier wheels (3). This makes it possible to lower it to the ground when it is being loaded and to lift it for movements.

The bucket (2) has a bottom (6) and two side walls (7). The rear side allows products to be loaded into the bucket (2). It can be closed using a panel (8) that is articulated on the bucket (2) using an axle (9), so as to make it possible to move the panel (8). As emerges from FIGS. 1 and 5, the front side of the bucket (2) is formed by a casing (10) having an opening (11) oriented toward the inside of the bucket (2) for the passage of the products from the bucket (2) toward the casing (10). The casing (10) also comprises an outlet orifice (12) on its perimeter (13). That outlet orifice (12) communicates with a discharge chute (14) that can be oriented to direct the flow of products. The casing (10) is in particular defined by a first wall (15), standing against the bucket (2) and pierced with said opening (11), and by a second wall (16), between which a turbine (17) is arranged.

As shown in FIG. 5, the turbine (17) comprises a disc (18) with blades (19) and knives (20). The disc is connected to a central part, such as a shaft. That central part carries a rotation axis (21) of the turbine around which the latter is driven during work. That rotation axis (21) is preferably substantially horizontal. Each blade (19) is oriented in a substantially radial direction of the disc (18). Each blade (19) extends from the disc (18) to a respective front face (22) adjacent to the opening (11) of the casing (10). In the example embodiment of the figures, this front face (22) is formed by a sheet metal piece extending substantially parallel to the disc (18). Seen from the opening (11), the front face (22) has a large surface area that gives it a certain rigidity able to absorb the forces exerted by the knives (20). At least one blade (19) extends from an inner side (23) adjacent to the rotation axis (21) to an outer side (24) adjacent to the knives (20) and connecting the front face (22) of that blade (19) to the disc (18). In the example of the figures, the outer side (24) is longer than the inner side (23). The front face (22) is remote from the disc (18) on said outer side (24). In the example of the figures, each blade (19) thus extends from the inner side (23) to the outer side (24).

At least part of the knives (20) of the turbine (17) are grouped together in rows. Within each row, the knives (20) are separated from each other by a certain pitch (p). As in particular shown in FIG. 7, this pitch (p) is preferably substantially constant so as to ensure regular chopping of the products. At least one row of knives (20) extends between the disc (18) and the front face (22) of a blade (19) and is arranged in the extension of that blade (19). This row of knives (20) is pivotably mounted on a fastening axis (25) connected to the disc (18) and arranged in the extension of the blade (19). Thus, in the event a foreign hard object is encountered, such as a stone, the knives (20) can retract by pivoting around the fastening axis (25) without being damaged. Said at least one row of knives (20) comprises a first knife (26) adjacent to the front face (22) and a last knife (27) adjacent to the disc (18). The various knives (20, 26, 27) preferably have a rectangular shape with large dimensions and are substantially parallel to each other. They comprise one or more cutting edges. During the rotation of the turbine (17), the knives (20, 26, 27) cooperate with counter knives (28, 29) arranged on the perimeter of the casing and shown in FIG. 5. The counter knives (28, 29) preferably assume the form of vanes oriented substantially perpendicular to a rotation plane of the turbine (17) and extending from the first wall (15) to the second wall (16) of the casing (10). Preferably, the machine for example comprises three stationary counter knives (28) and one adjustable counter knife (29) placed, when seen in the direction of rotation (SR) of the turbine (17), between the last stationary counter knife (28) and the outlet orifice (12).

In the example embodiment of the figures, each row of knives (20) extends between the disc (18) and the front face (22) of a respective blade (19) and is arranged in the extension of that respective blade (19). Furthermore, each row of knives (20) comprises a first knife (26) adjacent to the respective front face (22) and a last knife (27) adjacent to the disc (18). Each row of knives (20) is mounted on a respective fastening axis (25) connected to the disc (18) and arranged in the extension of a respective blade (19).

A distribution gearbox (30), shown in FIG. 1, is mounted in front of the casing (10). It comprises an inlet (31) that can be connected to a power takeoff shaft of the tractor (5), using an intermediate shaft. The shaft of the turbine (17) is connected to a first outlet of said gearbox (30).

An unraveling drum (32) provided with knives (33) is arranged in front of the opening (11) of the casing (10). The unraveling drum (32) is thus situated between the products loaded into the bucket (2) and the turbine (17). The unraveling drum (32) is mounted between the side walls (7) of the bucket (2). At its ends, it is guided in bearings fastened to said side walls (7), so as to be able to rotate around a longitudinal geometric axis. The unraveling drum (32) is driven in rotation, for example by means of transmission means that connect it to a second outlet of the distribution gearbox (30), or by means of a hydraulic motor. As shown by FIG. 2, the unraveling drum (32) comprises coil segments (34) on its periphery. The winding direction of each of these segments (34) can be reversed relative to that of the adjacent segment(s) (34). It is also possible to reverse the winding direction of the segment(s) (34) situated on half of the length of the unraveling drum (32) relative to that of the segment(s) (34) situated on the other half of the length of the unraveling drum (32). The coil segments (34) comprise straight sections (35) that are oriented in the rotation direction (F) of the unraveling drum (32). Knives (33) are advantageously fastened on these straight sections (35).

Above the unraveling drum (32) there is a regulation device (36) comprising retaining elements (37) and a deflecting wall (38). In the illustrated example, these retaining elements (37) are made up of several plates (39) that are substantially parallel to the side walls (7). They are fastened on the deflecting wall (38), which is movable relative to the unraveling drum (32), in at least two different positions. In a first position, which is shown in FIG. 3, the deflecting wall (38) is brought close to the unraveling drum (32). The passage section between the deflecting wall (38) and the unraveling drum (32) is thus much larger at its rear end than at its front end. In a second position, which is shown in FIG. 4, the deflecting wall (38) is separated from the unraveling drum (32). The passage between the deflecting wall (38) and the unraveling drum (32) thus has a substantially constant large section between its rear end and its front end.

The deflecting wall (38), which carries the retaining elements (37), is articulated, at its rear end, on a substantially horizontal axis (40) rigidly fastened to the side walls (7) of the bucket (2). The deflecting wall (38) is movable around said axis (40) using an adjustment device (41). This adjustment device can for example be a hydraulic jack, which is connected on the one hand to the deflecting wall (38) itself, and on the other hand to a side wall (7) of the bucket (2). This jack is connected to the hydraulic device of the tractor (5) by means of pipes and can be controlled, such that it opens or closes, from the latter. It thus makes it possible to move said deflecting wall (38) into the positions previously described.

A screen (42) is articulated on the deflecting wall (38) and extends said wall (38) toward products contained in the bucket (2). The screen (42) moves when the deflecting wall (38) is moved into its different work positions.

In the first position of the deflecting wall (38), each retaining element (37) is situated above the rear half of the unraveling drum (32) and extends into the trajectory of the knives (33). The screen (42) is brought closer to the product contained in the bucket (2).

In the second position of the deflecting wall (38), each retaining element (37) is situated above the front half of the unraveling drum (32) and extends a certain distance above the trajectory of the knives (33). The screen (42) is moved further away from the products contained in the bucket (2).

A conveying band (43) for moving the products is arranged at the bottom (6) of the bucket (2). That band (43) is made up of a conveying band driven such that it brings the product contained in the bucket (2) to the unraveling drum (32).

The products driven by the unraveling drum (32) cross the opening (11) of the casing (10) and arrive substantially at the center of the rotating turbine (17). They then slide along the blades (19) and over the disc (18), toward the perimeter (13) of the casing (10), where they are slowed down and slightly chopped by the three stationary counter knives (28) cooperating with the knives (20, 26, 27) of the turbine (17). In this way, the products present along the perimeter (13) are slowed down near the stationary counter knives (28). During their travel along the perimeter (13) of the casing (10), the products are accelerated by the effect of the blades (19) and the knives (20, 26, 27) of the turbine (17). At the level of the adjustable counter knife (29), the products are all the more slowed down more considerably as the adjustable counter knife (29) is closer to the trajectory of the knives (20, 26, 27) around the rotation axis (21). The intensity of the chopping can thus be adjusted by varying the distance between the knives (20, 26, 27) and said adjustable counter knife (29). The products thus chopped are next thrown out through the outlet orifice (12) toward the discharge chute (14), by blowing effect in particular due to the blades (19).

A space with a certain width must be respected between the front face (22) of the blades (19) and a first wall (15) of the casing (10), so as to limit power consumption of the machine (1) due to retention or even jamming of products in that space, and prevent a small foreign object, such as a stone, from becoming stuck in that space. At least one additional first knife (44) is arranged between the front face (22) of a blade (19) and the first wall (15) of the casing (10). That at least one additional first knife (44) is placed at a distance from the first wall (15) substantially equal to the pitch (p) between the different knives (20, 26, 27). This feature in particular appears in FIG. 7. Thus, in said space, the products are also chopped and cannot accumulate. The size of the products thrown out by the discharge chute (14) is more homogenous. FIG. 5 in particular shows that the turbine (17) comprises a plurality of additional first knives (44). Each of them is placed at a distance from the first wall (15) substantially equal to the pitch (p).

Preferably, the at least one additional first knife (44), in particular each additional first knife (44), is pivotably mounted on the corresponding fastening axis (25). That at least one additional first knife (44), in particular each additional first knife (44), can therefore, following the example of the other knives (20, 26, 27), retract by pivoting around the fastening axis (25) when it encounters an obstacle.

Preferably, the front face (22) of a blade (19) comprises, at an end remote from the rotation axis (21), a top sheet (45) carrying the fastening axis (25). The fastening axis (25) is therefore supported by the disc (18) and said top sheet (45). Such an assembly is very robust and allows the use of large knives (20, 26, 27, 44) with a high mass. When the turbine (17) rotates, such knives (20, 26, 27, 44) have, due to their high inertia, a particularly advantageous flail effect that effectively opposes the resistive forces generated by dense and/or wet products. Each row of knives (20, 26, 27) is arranged between the disc (18) and the corresponding top sheet (45). The at least one additional first knife (44), in particular each additional first knife (44), is arranged between a top sheet (45) and the first wall (15) of the casing (10).

Preferably, each first knife (26) is remote from the respective front face (22) with a value significantly smaller than the pitch (p). Also preferably, each last knife (27) is remote from the disc (18) with a value significantly smaller than the pitch (p). In this way, the row of knives (20, 26, 27) extends over a large width going practically from the disc (18) to the front face (22), that width substantially corresponding to that of the corresponding blade (19). Thus, the products sliding along the blade (19) from the center of the turbine (17) toward its periphery are all subjected to the action of the row of knives (20, 26, 27).

Preferably, the distance, measured parallel to the rotation axis (21), between the at least one additional first knife (44) and a first knife (26), in particular between each additional first knife (44) and each adjacent first knife (26), is substantially equal to the pitch (p). In this way, the chopping produced by the additional first knife (44), in particular by each additional first knife (44), is homogenous with respect to that generated by the other knives (20, 26, 27).

A space with a certain width must be respected between the disc (18) and the second wall (16) of the casing (10), so as to limit power consumption of the machine (1) due to retention or even jamming of products in that space, and prevent a small foreign object, such as a stone, from becoming stuck in that space. According to one advantageous feature of the invention, at least one additional second knife (46), shown in FIG. 7, is arranged between the disc (18) and the second wall (16) of the casing (10). Thus, possible products that may be present in that other area are also cut. The turbine (17) can comprise a plurality of additional second knives (46).

Preferably, the at least one additional second knife (46), in particular each additional second knife (46), is pivotably mounted on the corresponding fastening axis (25). The at least one additional second knife (46), in particular each additional second knife (46), can therefore, following the example of the other knives (20, 26, 27, 44), retract by pivoting around the fastening axis (25) when it encounters an obstacle.

Preferably, the at least one additional second knife (46), in particular each additional second knife (46), is placed at a distance from the second wall (16) at least equal to the pitch (p). Thus, the products present between the disc (18) and the second wall (16) are chopped appropriately and cannot accumulate. The size of the products thrown out by the discharge chute (14) is more homogenous.

As shown in FIG. 7, the at least one additional second knife (46), in particular each additional second knife (46), is preferably placed at a distance from the second wall (16) of the casing (10) comprised between one and two times the pitch (p) between the other knives (20, 26, 27, 44).

The arrangement of the respective two additional knives (44, 46), relative to the respective walls (15, 16) of the casing (10), allows the products to be chopped over a large width almost equal to that of the casing (10).

Preferably, the distance, measured parallel to the rotation axis (21), between the at least one additional second knife (46) and the last knife (27), in particular between each additional second knife (46) and each adjacent last knife (27), is substantially equal to the pitch (p). In this way, the chopping produced by the additional second knife (46), in particular by each additional second knife (46), is homogenous with respect to that generated by the other knives (20, 26, 27, 44).

FIG. 7 in particular shows that each fastening axis (25) carries a large number of knives (20, 26, 27, 44, 46), preferably nine to twelve knives. In the example of the figures, each fastening axis (25) carries eleven knives, nine of which form the row of knives (20, 26, 27) extending between the disc (18) and the top sheet (45). In this way, the chopping of the products is quick and regular.

Preferably, the knives (20, 26, 27) of at least one row of knives, in particular of each row of knives (20, 26, 27), are separated by spacers (51) pivotably mounted on the fastening axis (25) and shown in FIG. 7. These spacers (51) reduce the free section between the knives (20, 26, 27), and therefore increase the speed of the airflow generated by the rotating turbine (17). The products are thrown out of the machine (1) over a greater distance.

Preferably, a length of each spacer (51), measured in a substantially radial direction of the disc (18), is substantially equal to half of a length of the knives (20, 26, 27) measured in the same direction.

The turbine (17) comprises a plate (48). The plate (48) is adjacent to the opening (11). The plate (48) is remote from the disc (18). The plate (48) comprises a central plate (49). The central plate (49) is remote from the disc (18). The central plate (49) is adjacent to the opening (11). The central plate (49) is connected to the blades (19). During a rotation of the turbine (17) around the rotation axis (21), the products coming from the bucket (2) and crossing the opening (11) of the first wall (15) come into contact with the central plate (49), from which at least some of them next move along the blades (19) radially toward the periphery of the turbine. Also, some of the products coming from the bucket (2) and coming into contact with the central plate (49) are distributed and move radially at least between two adjacent blades (19).

The turbine (17) also comprises at least one branch (50). The at least one branch (50) is remote from the disc (18). It comprises the front face (22) of a blade (19). Said at least one branch (50) extends from a periphery of the central plate (49). The periphery of the central plate (49) is defined as a circular or globally circular line forming the outer contour of the central plate (49). Said at least one branch (50) originates at that line. The central plate (49) is then connected to the blade (19) whose front face (22) belongs to said at least one branch (50).

According to one advantageous feature of the invention, said at least one branch (50) extends toward the at least one additional first knife (44).

The plate (48) comprises said at least one branch (50). In the example embodiment of the figures, the plate (48) includes a plurality of branches (50). In that case, each branch (50) comprises the front face (22) of a respective blade (19). Each branch (50) extends from the periphery of the central plate (49) adjacent to the opening (11), remote from the disc (18) and connected to the blade (19) whose front face (22) belongs to that branch (50). Each branch (50) extends toward a respective additional first knife (44) from the periphery of the central plate (49).

According to one advantageous feature of the invention, said at least one additional first knife (44) is placed, according to the axis of rotation (21), substantially in the extension of a row of knives (20).

The central plate (49) and said at least one branch (50), in particular said plurality of branches (50), form a single and same plate (48). Thus, said at least one branch (50), in particular each branch (50), is placed in the continuation of the central plate (49), and the products can easily slide from the central plate (49) toward said at least one branch (50), in particular toward each branch (50), when the turbine rotates, without remaining caught in any location.

As shown by FIGS. 5 to 7, the central plate (49) and the disc (18) are connected to the central part carrying the rotation axis (21), at a distance from each other along said rotation axis (21). That connection of the central plate (49) and the disc (18) to the central part improves the rigidity of the turbine (17). Furthermore, the forces exerted by the knives (20, 26, 27, 44, 46) on the turbine are reacted over a larger length of the rotation axis (21). The presence of a large number of large knives, in particular of the at least one additional first knife (44) placed clearly overhanging the disc (18), therefore does not hinder the solidity of the turbine (17).

According to one significant feature of the invention, the central plate (49) is arranged, with regard to the rotation axis (21), set back from the front faces (22) of the blades (19). In this way, the plate (48), seen from the opening (11), has a substantially concave shape. Thus, a significant quantity of products can penetrate the casing (10) and arrive at the center of the turbine (17), from which it is next distributed along the rotating blades (19). Combined with the large chopping width, this feature allows the machine (1) to chop a significant flow rate of products with a substantially even chopping quality over the entire width of the turbine (17) casing (10) in which the products are distributed.

In particular, an outer distance between the front face (22) of a blade (19) and the disc (18) is at least substantially twice as long as an inner distance separating the central plate (49) from the disc (18).

As in particular illustrated by FIGS. 5 and 6, at least one blade (19), in particular each blade (19), comprises at least one lateral closing sheet (47) which extends from the inner side (23) adjacent to the rotation axis (21) to the outer side (24) adjacent to the knives (20, 26, 27) and connecting the corresponding front face (22) to the disc (18). The outer distance separating that front face (22) from the disc (18) then corresponds to the length of the outer side (24), while the inner distance separating the central plate (49) from the disc (18) corresponds to the length of the inner side (23). The figures in particular show that at least one lateral closing sheet (47), in particular each closing sheet (47), has a globally trapezoidal shape that becomes wider from the rotation axis (21) to the fastening axis (25) of the knives (20, 26, 27, 44, 46). The blade (19), in particular each blade (19) thus obtained has a large section and makes it possible to blow the products and throw them out through the discharge chute (14) at a large distance from the machine (1).

According to one particularly advantageous feature of the invention, the periphery of the central plate (49) is connected to the disc (18) by an inner side (23), in particular by each inner side (23). This means that a lateral closing sheet (47), in particular each lateral closing sheet (47), originates at the periphery of the central plate (49). In this way, the products arriving at the center of the turbine (17) and sliding along said lateral closing sheet (47), in particular along each lateral closing sheet (47), easily go from the central plate (49) toward said lateral closing sheet(s) (47). Furthermore, products cannot accumulate between the front plate (49) and the disc (18). It can be seen from FIG. 6 that the two lateral closing plates (47) adjacent to two consecutive blades (19) come together by their respective inner sides (23).

According to one important feature of the invention, at least one branch (50) extends along at least one corresponding lateral closing plate (47) from the central plate (49). The corresponding blade (19) is formed by that branch (50) and said at least one lateral closing plate (47). In the example embodiment in particular illustrated by FIG. 6, each branch (50) extends along at least the corresponding lateral closing sheet (47) from the central plate (49). Furthermore, each blade (19) is formed by said respective branch (50) and said at least one respective lateral closing sheet (47). Since each branch (50) of the plate (48) covers the corresponding lateral closing sheet (47), the more or less trapezoidal shape of which it follows, the products arriving at the central plate (49) of the turbine (17) can easily slide along the branches (50) toward the space situated between the front face (22) of the branches (50) and the first wall (15) of the casing (10), in particular toward the additional first knife or knives (44).

At least one branch (50), in particular each branch (50), is connected to the disc (18) by two lateral closing sheets (47) to form a bin. The corresponding blade (19), in particular each blade (19), is formed by that bin. The blade (19), in particular each blade (19), thus obtained has a high rigidity. This rigidity allows the blade (19), in particular each blade (19), to absorb, with minimal deformation, significant forces generated by the chopping of dense and/or wet products, as well as those caused by the inertia of the many large knives (20, 26, 27, 44, 46). The turbine (17) in its entirety also has a high rigidity. This is made necessary by the numerous many large knives (20, 26, 27, 44, 46) and the large chopping width, which generates significant forces on the turbine (17) during work.

The outlet orifice (12) of the casing (10) shown in FIG. 5 is delimited by the first wall (15), the second wall (16) and a product recycling sheet (52). That recycling sheet (52) comprises a lower end (53) and an upper end (54). The lower end (53) is close to a trajectory of the knives (20, 26, 27, 44, 46) around the rotation axis (21). The upper end (54) is remote from said trajectory. During one revolution of the turbine (17), a lighter and/or sufficiently chopped portion of the products is thrown out through the outlet orifice (12). The other denser and/or insufficiently chopped portion falls between the knives (20, 26, 27, 44, 46) and the recycling sheet (52) instead of being thrown out. The arrangement of the lower (53) and upper (54) ends relative to the trajectory of the knives (20, 26, 27, 44, 46) yields a funnel effect that forces the products to be taken back by the knives (20, 26, 27, 44, 46) until they are light enough and/or chopped into strands short enough to be thrown out. In fact, this recycling sheet (52) reduces the risk of the densest products accumulating at the outlet orifice (12), and contributes to homogenous chopping of all of the products introduced into the casing (10).

Preferably, the upper end (54) of the recycling sheet (52) is connected to the discharge chute (14) throwing out products. Thus, the products that cross the outlet orifice (12) penetrate the discharge chute (14) to be distributed for example in the form of bedding or fodder.

According to one advantageous feature of the invention shown in FIG. 5, a first guidance sheet (55) stands against the first wall (15) of the casing (10). The first guidance sheet (55) is arranged between the turbine (17) and the outlet orifice (12) of the casing (10). The function of this guidance sheet (55) is to prevent the products arriving from the bucket (2) and crossing the opening (11) of the casing (10) from being thrown out without first being picked up by the turbine (17) to be chopped. To that end, that first guidance sheet (55) has a size, measured along the rotation axis (21), substantially equal to the pitch (p) between the knives (20, 26, 27, 44, 46). It does not limit the flow rate of the products.

Similarly, a second guidance sheet (56) advantageously stands against the second wall (16) of the casing (10). The second guidance sheet (56) is arranged between the turbine (17) and the outlet orifice (12) of the casing (10), and has a size, measured along the rotation axis (21), at least equal to the pitch (p) between the knives (20, 26, 27, 44, 46). In this way, the distance separating the two guidance sheets (55, 56) is substantially equal to the distance separating the two additional knives (44, 46). The two guidance sheets (55, 56) do not limit the flow rate of the chopped products that have just been thrown out.

Preferably, the first guidance sheet (55) and/or the second guidance sheet (56) have a curve radius slightly larger than the radius of the trajectory of the knives (20, 26, 27, 44, 46) around the rotation axis (21). Thus, the two guidance sheets (55, 56) follow the trajectory of the knives (20, 26, 27, 44, 46) at a small distance therefrom, preventing products from passing between said metal sheets (55, 56) and the knives (20, 26, 27, 44, 46).

The first guidance sheet (55) and the second guidance sheet (56) each have a lower portion (57). The respective lower portions (57) can be connected by a horizontal metal sheet (58), shown in FIG. 5, which makes it possible to slow down the long strands so that they fall between the turbine (17) and the recycling sheet (52). In this way, they are chopped until they are short enough.

Each row of knives (20, 26, 27) and the additional first and second knives (44, 46) cooperate with the counter knives (28, 29), and in particular with the adjustable counter knife (29) shown in FIG. 5. The latter is adjusted by means of an adjustment device (59). The latter can be manual, or comprise a hydraulic jack articulated to the casing (10) and connected to a remote control unit of the machine (1). Said jack is connected to the hydraulic device of the tractor (5) by means of pipes. The control unit can be placed in the cab of the tractor (5) from which the position of the adjustable counter knife (29) can be adjusted. Depending on the products, the user can easily vary the distance between the adjustable counter knife (29) and the knives (20, 26, 27, 44, 46) of the turbine (17), and thus determine the intensity of the chopping.

During work, the bucket (2) can be loaded with fodder or straw in bulk or in the form of bales or blocks. For direct distribution, the machine (1) is brought to the distribution location using the tractor (5). Next, the turbine (17) and the unraveling drum (32) are driven in rotation. The unraveling drum (32) rotates from bottom to top over its rear half, i.e., in the direction indicated by the arrow (F). When the bucket (2) is loaded with a bale or when the products are dense and/or wet, the deflecting wall (38) and the retaining elements (37) are brought closer to the unraveling drum (32) in the first position. The knives (33) and the coil segments (34) of the unraveling drum (32) detach a certain quantity of products from the mass contained in the bucket (2) and cause it to pass into the casing (10). The products taken by the unraveling drum (32) enter the passage between the latter and the deflecting wall (38). The retaining elements (37) retain the products in the bucket (2) and prevent the large bundles of product from accessing the opening (11) of the casing (10). These bundles slide upward along the rear parts of those elements (37) and along the screen (42) and fall into the bucket (2). The separation between the retaining elements (37) is sufficient not to hinder the passage of correctly unraveled products. During the rotation of the unraveling drum (32), its coil segments (34) stir and drive the products to prevent an arch from forming. The products thus arrive in the turbine (17) regularly. In the presence of straw or dry and light products, the deflecting wall (38) and the retaining elements (37) are remote from the unraveling drum (32) in the second position by means of the adjustment device (41). The products are then no longer stopped by the retaining elements (37). They rush into the passage that is more open between the unraveling drum (32) and the deflecting wall (38). The latter orients those products toward the front half of the unraveling drum (32), where they are caught by the knives (33), so as to be able to pass between the front ends of the retaining elements (37). Said cut products then reach the turbine (17). The latter is able to homogenously chop, over the entire width of the casing (10), a significant volume of these various aforementioned products, which are more or less difficult to work. The configuration of the casing (10) with the guidance sheet(s) (55, 56), the recycling sheet (52) and the horizontal sheet (58) contributes to the quality of the chopping, in particular of dense and/or long-stranded products. The turbine (17) next throws out the recut products through the outlet orifice (12). The product can then be oriented by means of the discharge chute (14) toward the troughs, when it involves feed, or toward the bedding, when it involves straw. The discharge chute (14) can also be oriented so as to form a heap of chopped products to be subsequently incorporated into a machine such as a mixer. The machine (1) according to the invention can also be used for lagoon bedding or distribution of chopped products on the ground to form a cover. Outside the first and second positions of the deflecting wall (38), the adjustment device (41) may also allow intermediate positions based on the nature of the products.

In order to mix different products loaded in the bucket (2) before they are distributed, the unraveling drum (32) and the turbine (17) are driven in rotation as previously described. The deflecting wall (38) is moved into the second position by pivoting around its axis of articulation (40) by means of the adjustment device (41). The retaining elements (37) pivot with said wall (38) and are situated above the front half of the unraveling drum (32) and at a certain distance above the trajectory of the knives (33). The bundles of products are no longer stopped by the retaining elements (37). They rush into the passage that is more open between the unraveling drum (32) and the deflecting wall (38). That latter orients these products toward the front half of the unraveling drum (32), where they are cut by the knives (33), in order to be able to pass between the retaining elements (37). The screen (42) prevents the upward projection of the products and guides them toward the passage between the deflecting wall (38) and the unraveling drum (32). Said cut products then reach the turbine (17), which throws them out via the discharge chute (14), which is oriented toward the rear, so that they fall back into the bucket (2) and mix. These products can thus pass through the unraveling drum (32) and the turbine (17) two or three times, so as to obtain a completely homogenous mixture. Next, the orientation of the discharge chute (14) can be modified to throw out the products into the troughs.

Based on the position of the adjustable counter knife (29), the machine (1) can chop straw into short strands of three to five centimeters, grind difficult product such as wet straw or hay into long strands from five to ten centimeters, or even throw out the products practically without recutting them.

The invention is of course not limited to the example embodiment described above and shown in the appended figures. Modifications remain possible, in particular regarding the composition or number of the various elements or by substituting technical equivalents, without however departing from the scope of protection.

1-19. (canceled)

20. A machine for distribution of products for feeding or bedding of animals, comprising:
a bucket including an opening for passage of the products toward a casing including a first wall pierced by the opening and a second wall between which a turbine is mounted that can rotate around a rotation axis,
the turbine including a disc including rows of knives and blades oriented in a substantially radial direction of the disc and each extending from the disc to a respective front face adjacent to the opening,
at least one row of knives extending between the disc and a front face of a blade and being arranged in an extension of that blade, the at least one row of knives including a first knife adjacent to the front face and a last knife adjacent to the disc, at least one additional first knife being arranged between the front face of a blade and the first wall of the casing,
the turbine including at least one branch including the front face of a blade, and the at least one branch extends from a periphery of a central plate adjacent to the opening, remote from the disc and connected to the blade whose front face belongs to the at least one branch.

21. A distribution machine according to claim 20, wherein the at least one branch extends toward the at least one additional first knife.

22. A distribution machine according to claim 20, wherein the at least one additional first knife is placed, along a rotation axis, substantially in the extension of a row of knives.

23. A distribution machine according to claim 20, wherein each row of knives extends between the disc and the front face of a respective blade and is arranged in the extension of that respective blade, and each row of knives includes a first knife adjacent to the respective front face and a last knife adjacent to the disc.

24. A distribution machine according to claim 20, wherein the at least one row of knives is pivotably mounted on a fastening axis connected to the disc and arranged in the extension of a blade.

25. A distribution machine according to claim 20, wherein the central plate and the at least one branch form a single and same plate.

26. A distribution machine according to claim 25, wherein the plate is itself remote from the disc.

27. A distribution machine according to claim 20, wherein the rotation axis of the turbine is carried by a central part to which the central plate and the disc are connected remote from each other along the rotation axis.

28. A distribution machine according to claim 20, wherein the central plate is arranged, along the rotation axis of the turbine, set back from the front faces of the blades such that, seen from the opening, the plate has a substantially concave shape.

29. A distribution machine according to claim 28, wherein an outer distance between the front face of a blade and the disc is at least substantially twice as long as an inner distance separating the central plate from the disc.

30. A distribution machine according to claim 20, wherein at least one blade comprises at least one lateral closing sheet that extends from an inner side adjacent to the rotation axis to an outer side adjacent to the knives and connecting the corresponding front face to the disc.

31. A distribution machine according to claim 30, wherein the periphery of the central plate is connected to the disc by the inner side.

32. A distribution machine according to claim 30, wherein a branch extends along the at least one lateral closing sheet from the central plate, and the at least one blade is formed by the branch and by the at least one lateral closing sheet.

33. A distribution machine according to claim 20, wherein the knives of each row of knives are separated from each other by a certain pitch, and the turbine includes a plurality of additional first knives each placed at a distance from the first wall substantially equal to the pitch.

34. A distribution machine according to claim 20, wherein the control plate includes a plurality of branches each extending from the periphery of the central plate toward a respective additional first knife.

35. A distribution machine according to claim 34, wherein each branch extends along at least one corresponding lateral closing sheet from the central plate, and each blade is formed by the respective branch and by the at least one respective lateral closing sheet.

36. A distribution machine according to claim 32, wherein the branch is connected to the disc by two lateral closing sheets to form a bin, and the blade of the turbine is formed by the bin.

37. A distribution machine according to claim 20, wherein at least one additional second knife is arranged between the disc and the second wall of the casing.

38. A distribution machine according to claim 20, wherein the knives of at least one row of knives are separated by spacers, and a length of each spacer, measured in a substantially radial direction of the disc, is substantially equal to half of a length of the knives measured in a same direction.
